(19) United States
(12) Patent Application Publication
(10) Pub. No.: US 2006/0262115 A1
(43) Pub. Date: Nov. 23, 2006

(54) Statistical machine learning system and methods

(76) Inventor: Graham Hershal Shapiro, Los Angeles, CA (US)

Correspondence Address: Graham Shapiro, 950 Gayley Av. #108, Los Angeles, CA, 90024, US

(21) Appl. No.: 11/414,854

(22) Filed: May 1, 2006

Related U.S. Application Data
(60) Provisional application No. 60/676,816, filed on May 2, 2005.

(51) Int. Cl. G06T 15/00

(52) U.S. Cl. 345/419

(57) ABSTRACT

A sequence walk model associates connections with system states. The model is capable of modeling systems that have liner state sequences. Intuitively a system modeled by a sequence walk model is like an object moving around a set of locations. The connections the object uses determine which locations the object will move to. And the locations the object moves to determine the connections that can be used by the object. In the same way the states of a system in the past may determine the sates of a system in the future. The process of moving from location to location is known as a walk process and the mathematical properties of walk processes have been well developed over time. The properties of a walk process are parameters of a sequence walk model. The present invention is a machine learning system that utilizes sequence walk model technology. A sequence walk model is a framework or a model that is assigned parameters with the intention of obtaining an optimal functionality and hence becomes available to perform a wide range of varied functions which may be carried out by the ultimate end user of the sequence walk model. The system described in the present invention is capable of, among other things, predicting the behavior of a system, classifying an unlabeled system, operating as a system with custom functionality, being a system with functionality that imitates the functionality of another system and providing greater understanding and knowledge of real-world systems.

### CROSS REFERENCES TO RELATED APPLICATIONS

This application claims the benefit of the provisional patent application Ser. No. 60/676,816, filed in the United States on May 2, 2005 by the present inventor.

### BACKGROUND OF INVENTION

1. Field of Invention

The present invention relates to the field of statistical machine learning techniques and, more particularly, to machine learning using machine learning models.

2. Prior Art

Machine learning models are becoming very popular in diverse fields. In the field of speech recognition audio signals from a microphone are processed and interpreted as a system that emits phonemes. Machine learning models are used to model the sequences of phonemes emitted from the system in such a way that allows what was likely spoken to be recognized. Also in the field of computational biology, biological sequences are extracted from actual tissue samples. These sequences are interpreted as systems called state machines which enables them to be modeled by machine learning models. These modeling methods are very useful and have been used to decipher the function and operation of countless genomes. Common examples of machine learning models are neural networks, decision trees, support vector machines and, to a great extent, hidden Markov models.

In 2004 Sean Eddy in the journal Nature Biotechnology discussed these models in an article headlined “Statistical models called hidden Markov models are a recurring theme in computational biology. What are hidden Markov models, and why are they so useful for so many different problems?” A Hidden Markov model, or an HMM, is a statistical model of a linear sequence. They are at the heart of a diverse range of uses, including gene finding, profile searches, multiple sequence alignment and regulatory site identification.

An HMM models a system that has hidden states. These hidden states however are often fictitious states that are imagined to best describe the operation of the system. The accuracy of the model is determined by the accuracy of one's knowledge of the underlying system. The parameters of the model are the transition probabilities given a current state. The values the system emits are used to determine the probability that the system is in any particular hidden state. This method is used, for example, to discover splice sites in nucleic acid sequences. The sections of the DNA that are used for producing proteins are divided into coding regions called exons and non-coding regions called introns. The sections of the sequence that divide the coding and non-coding regions are called splice sites. FIG. 16, a diagram of a hidden Markov model configured to model a DNA splice site, models the probability that each nucleic acid in a nucleic acid sequence is evidence that the system is transitioning to a intron state 71, a splice site state 74 or an exon state 73. After passing a start of sequence state 70, a transition possibility 75 determines if the system can transition to a different state. A loop back transition possibility 72 determines if the system can transition back to the same state before reaching the end of sequence state 76. These models are limited however because they are based on Markov chains.

The parameters of a Markov chain, depicted in FIG. 17, a diagram of a Markov chain configured to model a DNA system, are the transition probabilities given a current state. With a Markov chain there are no hidden states. The structure of a Markov chain is rigid and lacks flexibility because there is one state 77 in the model for each state of the system being modeled. With a system of nucleic acids, the parameters of a Markov chain are the probabilities that a particular acid will follow another acid. FIG. 17 depicts a system of nucleic acids that transition from one acid by a transition possibility 75, to any other acid or back to the same acid by a loop back transition possibility 72. The set of transition probabilities is called the transition matrix. At the core of all Markov systems is the Markov assumption that the system is memoryless. The probability of the next state is determined only by the current state and not by the history of the system.

The method used to model non-memoryless systems with Markov models is higher order Markov models. Higher order Markov models interpret the current state as being one of any combination of the previous states. The number of previous states is determined by the order of the model. The computational requirements for higher order Markov models grows exponentially as the order of the model increases which makes them infeasible for most machine learning problems.

A random walk is the process by which a walker is moved about randomly. There are many mathematical properties associated with random walks. They are used to analyses the behavior of systems that are considered random processes such as the stock market. Also they are used to study the properties of graphs.

In the early 90s it was discovered that a walk operation on a surface that was not random, but rather was formed from a sequence of DNA, formed fractal patterns that revealed properties of the DNA system. This is a rapid method used to analyze nucleic acids that is not memoryless. In a DNA walk, FIG. 18, a diagram of a DNA walk, each element 81, is assigned to one of four directions using an element to direction assignment 78. Then, given a start of path 79 a line is drawn a short distance in the direction of the corresponding nucleic acid. A path 80 on a surface is created as this process is repeated until an end of sequence 82 is reached. Walking processes are not memoryless because the location of each step is determined by the combination of all the steps prior to it.

Analysis of a DNA walk is limited to techniques such as fractal geometry because the properties of the walk process can only be determined from the perspective of the whole surface on which the walk occurs.

What is needed then is a model that incorporates state transition probabilities and walk process memory. Such a model, called a sequence walk model, is presently lacking in the prior art.

### SUMMARY

A sequence walk model associates connections with system states. The model is capable of modeling systems with a liner sequence of states. Intuitively a system modeled by a sequence walk model is like an walker moving around a set of locations. The connections the walker uses determine which locations the walker will move to. And the locations the walker moves to determine the connections that can be used by the walker. In the same way the states of a system in the past may determine the sates of a system in the future. The process of moving from location to location is known as a walk process and the mathematical properties of walk processes have been well developed over time. The properties of a walk process are parameters of a sequence walk model.

The states of a system when modeled with a sequence walk model are not associated directly with locations, as with state transition diagrams, but are rather associated with connections. A state can occur at different locations in the sequence walk model.

A sequence walk model is a framework or a model that is assigned parameters with the intention of obtaining an optimal functionality and hence becomes available to perform a wide range of varied functions which may be carried out by the ultimate end user of the sequence walk model.

Modeling real-world systems with artificial ones is extremely common. Examples of real-word systems that are subject to being modeled are innumerable. These include systems of biological sequences, vocal emissions, music, automobile traffic, temperature readings, chemical reactions, work-flow, neuron behavior or any system that can be interpreted as a liner sequence of states.

Some of the wide range of varied functions that become available with a sequence walk model that has been optimally parametized are described here. With a sequence walk model a system can be summarized as a set of parameters that can be quickly compared to the parameters of a model of another system. A sequence walk model is capable of predicting the behavior of a system. A sequence walk model is capable of operating as an original system with custom functionality. A sequence walk model is capable of being a system with functionality that imitates the functionality of another system. A sequence walk model is capable of providing knowledge of real-world systems.

However, to achieve an optimum level of practical functionality the model is subject to a plurality of functional steps or processes. Training is the process by which the parameters of the model are configured to produce the desired functionality. The desired functionality may be to imitate a real world system or it may be to create a custom or original functionality. Synthesis is the process by which the parameters of the model are utilized to perform the desired functionality. Also the synthesis process can be used to obtain knowledge of a systems probable performance. Evaluation is the the process of obtaining knowledge of the probable identity of an unknown system.

Accordingly the present invention may have one or more of the following advantages:
provides sufficient flexibility and adaptability to be useful for a variety of functions
combines a state transition process with a walk process
capable of modeling memoryless and non-memoryless systems
utilizes universal order embedded in geometrical forms instead of relying on user defined order
low computational complexity is required to model non-memoryless systems
utilizes simple algorithms that are easy to understand and implement.
does not require prior knowledge of the behavior of the underlying system
inherently adept at modeling systems such as nucleic acids
capable of modeling discreet time systems as well as continuous time systems

Further advantages will become apparent from consideration of the ensuing description and drawings.

### DRAWINGS AND TABLES

Table I—Sequence modeled with the model depicted in FIG. 4 with vertex sequence, interval sequence and sub-sequences.

FIG. 1—Unified Modeling Language model of a sequence walk model system consisting of object oriented interface components

FIG. 2—Unified Modeling Language model of a sequence walk model system integrated into a hidden Markov model system consisting of object oriented interface components

FIG. 3—Unified Modeling Language model of a sequence walk model configured for modeling of a continuous time system consisting of object oriented interface components

FIG. 4—Digraph diagram of a sequence walk model structured as a hyper-tetrahedron with four connections at each vertex and with symmetrical connection associations

FIG. 5—Digraph diagram of a sequence walk model structured as an octahedron with four connections at each vertex

FIG. 6—Digraph diagram of a sequence walk model structured as a cube with three connections at each vertex and with symmetrical connection associations

FIG. 7—Digraph diagram of a sequence walk model with five connections at each vertex and with symmetrical connection associations

FIG. 8—Detailed view of a vertex with parameters for each connection

FIG. 9—Detailed view of a vertex with a guide switch and parameters

FIG. 10—Flowchart of sequence walk model training process

FIG. 11—Flowchart of sequence walk model synthesis process

FIG. 12—Flowchart of sequence walk model evaluation process

FIG. 13—Flowchart of hidden Markov model state distribution and transition matrix training using a sequence walk model

FIG. 14—Sample parameter values from a connection in a hyper-tetrahedron shaped sequence walk model

FIG. 15—A diagram of a system containing at least one computer

FIG. 16—A diagram of a hidden Markov model configured to model a DNA splice site

FIG. 17—A diagram of a Markov chain configured to model DNA

FIG. 18—A diagram of a DNA walk

### DEFINITIONS OF TERMINOLOGY

Connection—A line, edge or direction leading to a vertex or location.

Interval—The amount of time and/or distance between vertexes or locations in a path.

Location—A portion of space such that any two points having a distance of zero share the same location. A relation between a pair of locations is connectedness.

Machine Learning Model—A system that explains the behavior of another system, optimally at the level where some alteration of the model predicts some alteration of the other system. Machine Learning Models include both parametized models and predictive models. Common examples of machine learning models are neural networks, decision trees, support vector machines and hidden Markov models.

Memory—The set of past events affecting a given event in a stochastic process.

Parameter—One of a set of measurable factors, such as transition probability and rate, that define a system and determine its behavior and are variable.

Relative Vertex—A vertex of a model identified with a paticular path from a given vertex. The relative vertecies can be uniformly identified in a symmetrical model by either being the given vertex, having no path, or by a short path to the vertex. The eight relative vertexes of the hyper-tetrahedron in FIG. 4 are the given vertex, A, T, C, G, AG, TA and CA.

State—A condition or mode transmitted by an system to an observer. An element of a liner sequence.

State Set—The set of states a system is capable of transmitting.

Symmetrical Model—A sequence walk model with state to connection associations such that if a path created by state sequence creates a cycle at one vertex it also creates a cycle at any vertex.

Vertex—A node of a graph. One of the points on which the graph is defined and which may be connected by graph edges. The term “location” may also used.

### DETAILED DESCRIPTION—PREFERRED EMBODIMENTS

Software Interface Structure

FIG. 15, a diagram of a system containing at least one computer, illustrates a system 57 that is operated in accordance with one embodiment of the present invention. System 57 comprises at least one computer 58. Computer 58 comprises standard components including a central processing unit 59, memory 66 and non-volatile storage 64 such as disk storage for storing program modules and data structures, user input/output device 60, a network interface 65 for coupling server 58 to other computers via a communication network (not shown), and one or more busses that interconnect these components. User input/output device 60 comprises one or more user input/output components such as a mouse 61, display 62, and keyboard 63.

Memory 66 comprises a number of modules and data structures that may be used in accordance with the present invention. It will be appreciated that, at any one time during operation of the system, a portion of the modules and/or data structures stored in memory 66 is stored in random access memory while another portion of the modules and/or data structures is stored in non-volatile storage 64. In a typical embodiment, memory 66 comprises an operating system 67. Operating system 67 comprises procedures for handling various basic system services and for performing hardware dependent tasks. In some embodiments a file system is a component of operating system 67. Also memory 66 contains a virtual machine 68, such as a Java Virtual Machine. A virtual machine 68 contains an object heap 69. An object heap 69 contains a plurality of instances of interfaces. A plurality of instances of any interface may exist in the object heap 69 at any time. The interfaces that comprise the present invention are described in the software interface structure of the present document.

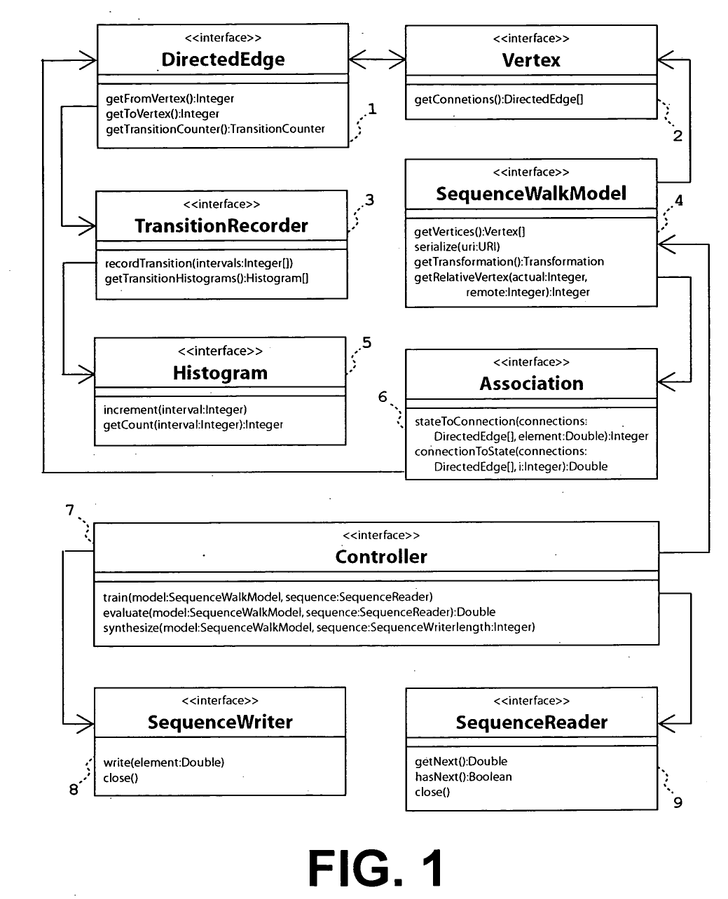

The software interface structure of the preferred embodiment of the present invention is depicted in FIG. 1, a Unified Modeling Language model of a sequence walk model system consisting of object oriented interface components. Listed in each interface is a set of methods with input and return parameters. The methods of an interface define its properties and behavior. The arrows connecting the interfaces depict dependencies between the interfaces.

A Controller interface 7 has a set of methods for performing operations on one or more instances of a SequenceWalkModel interface 4. Each SequenceWalkModel interface is associated with a plurality of Vertex interfaces 2. Each Vertex interface is associated with a plurality of DirectedEdge interfaces 1. Each DirectedEdge interface has an incoming and outgoing Vertex interface associated with it. Also associated with each DirectedEdge interface is a TransitionRecorder interface 3. Each TransitionRecorder interface is associated with a plurality of Histogram interfaces 5. A SequenceWalkModel interface also is associated with a Association interface 6. The Controller interface also has access to a SequenceReader interface 9 and a SequenceWriter interface 8.

Controller interface 7—This interface is a controller and performs operations on one or more sequence walk models at a time. The operations the controller executes include the processes that are depicted in the Controller interface in FIG. 1. These processes, train, evaluate and synthesize are described in detail in the operations section of this document. The controller is responsible for the construction of sequence walk models. The construction is done by instantiating the SequenceWalkModel interface, Association interface, Vertex interfaces, DirectedEdge interfaces, TransitionRecorder interfaces and Histogram interfaces, and setting the correct associations between them. Also the controller is responsible for keeping track of process specific details such as intervals and the active vertex. In addition the controller is responsible for the operation of the SequenceReader interface and the SequenceWriter interface.

SequenceWalkModel interface 4—This interface is a sequence walk model and has a method, getVerfices, for retrieving an array of all the Vertex interfaces associated with the model. A method, getAssociation, provides access to the Association interface associated with the model. A method, serialize, allows the model and all of its associated parts to be quickly copied from the active memory sate to a format ready for being stored. The getReletiveVertex method returns the index of the Vertex interface that has the correct relative relationship to the active Vertex interface.

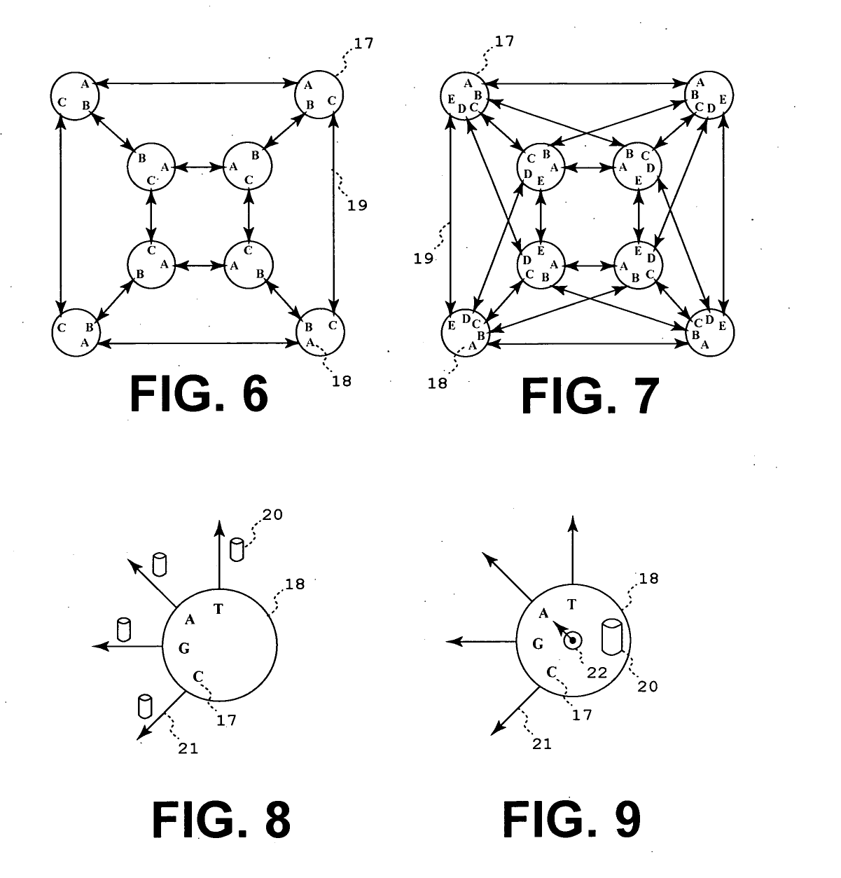

Vertex interface 2—This interface is a location and has a method, getConnectons, for retrieving an array of all associated connections. The vertices in each of FIG. 4, FIG. 5, FIG. 6 and FIG. 7 each have the same number of connections, or adjacent directed edges. This property is called graph regularity. It enables the convenient association of one directed edge for each member of a state set. The models in FIGS. 4 & 5 are useful for modeling sequences of nucleic acids which have four bases.

DirectedEdge interface 1—A DirectedEdge interface is a connection that connects a pair of vertexes. During the training process the connections of a vertex are associated with states of a system as depicted in FIG. 8. The DirectedEdge interface has a method, getToVertex, for retrieving the index of the connection's destination vertex in the SequenceWalkModel interface's array of vertices and a method, getFromVertex, for retrieving the index of the connection's source vertex. A method, getTransitionCounter, is also available for retrieving the TransitionCounter interface associated with the connection.

TransitionRecorder interface 3—This interface is a parametization means and is responsible for maintaining parameters of the sequence walk model as set of Histogram interfaces. A method, getTransitionHistograms, returns an array of Histogram interfaces, one for each Vertex interface associated with the SequenceWalkModel interface. Also a method, recordtranstion, records a set of intervals into the set of Histogram interfaces, one for each vertex of the sequence walk model.

Histogram interface 5—This interface stores parameters of the model. Each bin holds a value of how often a transition is made using a connection given an interval value for a particular vertex of the sequence walk model. The Histogram interface has a method, increment, for incrementing the bin at a given interval value. Also a method, getcount, is available for getting the count of a bin given the interval value.

Association interface 6—This interface is an association means which associates states of a system with the connections of a vertex. The Association interface has a method, stateToConnection, to associate a state with an index of a connection array associated with a Vertex interface. The method connectionToState, given an index from a connections array, returns a state.

SequenceReader interface 9—This provides access to state sequences of a system for use by the controller. Each state of the sequence is formalled as a double variable. The sequence can physically be located in a file or the interface can connect to a variety sources. A hasNext method is available for checking if there are any remaining states available to be read. A getNext method is available for acquiring the next state of the state sequence. The controller calls the close method when reading of the sequence is complete.

SequenceWriter interface 8—This provides a means for the controller to output state sequences of a system. The interface can be implemented to write an output state sequence to a file, over a network or it can be used output to a variety of destinations. The write method is used to append an element to the output state sequence. The controller calls the close method when the output state sequence is complete.

Sequence Walk Model Structure

When the interfaces have been implemented they form the components of a sequence walk model system. A sequence walk model has a graph structure and can be configured in many different shapes. The structure of a sequence walk model may vary to optimize the intended eventual function of the model.

A possible configuration of the present invention is depicted in FIG. 4, a digraph diagram of a sequence walk model shaped as a hyper-tetrahedron with four connections at each vertex and with symmetrical state associations, also FIG. 5, a digraph diagram of a sequence walk model shaped as an octahedron with four connections at each vertex, also FIG. 6, a digraph diagram of a sequence walk model shaped as a cube with three connections at each vertex and with symmetrical state associations and also FIG. 7, a digraph diagram of a sequence walk model with five connections at each vertex and with symmetrical state associations. Each of these configurations are structured as finite and connected graphs.

The depicted digraphs contain a plurality of vertexes 18, connections in opposing directions 19, and state to connection associations 17 which associate the states of a system with the connections of a vertex. FIG. 8, detailed view of a vertex with transition recorders for each connection, is a detailed graphical representation of a single vertex. A plurality of single directed connections 21 are adjacent to the vertex. Associated with connection edge is a transition recorder 20 for maintaining parameters.

Operation—Training

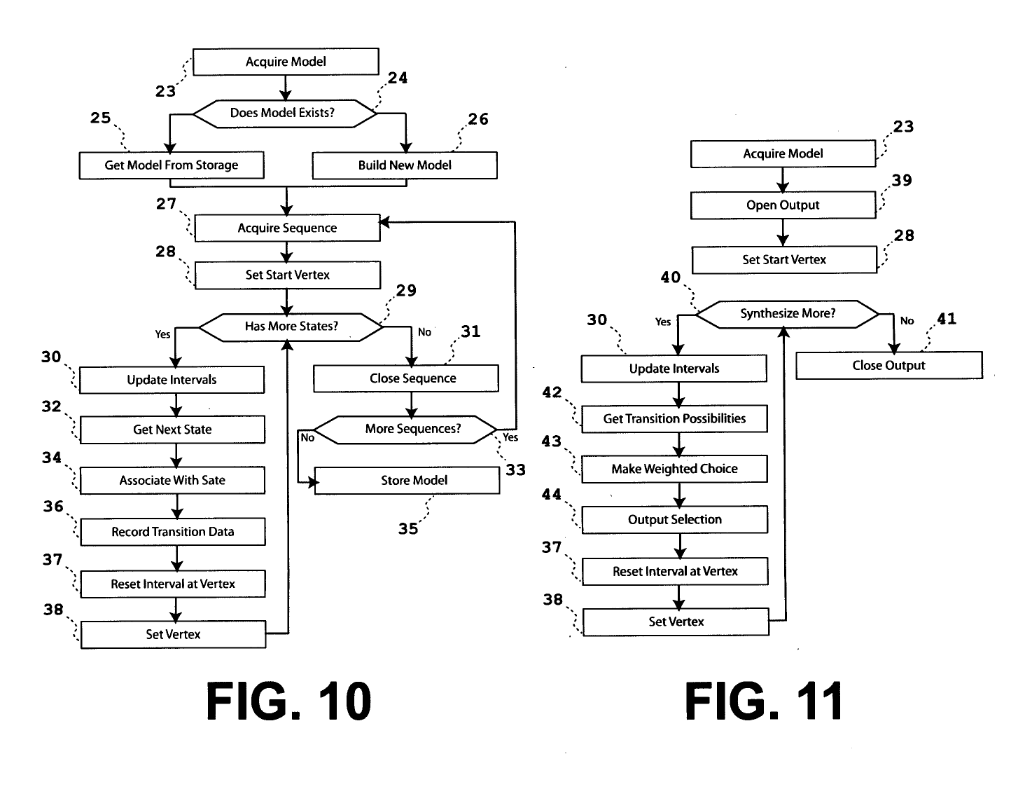

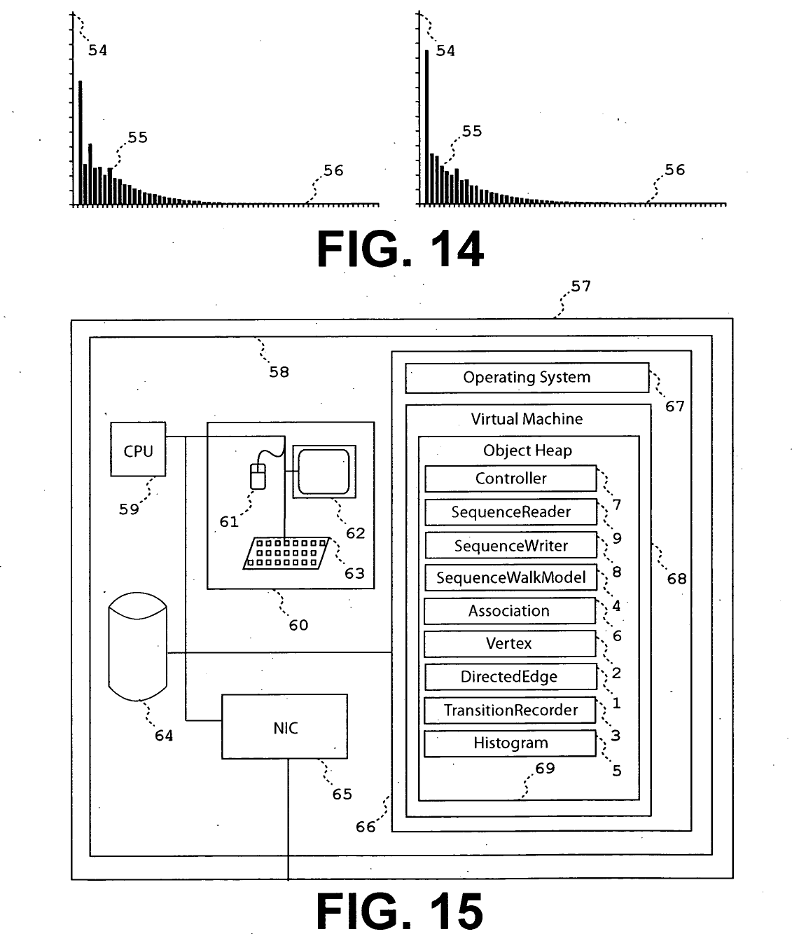

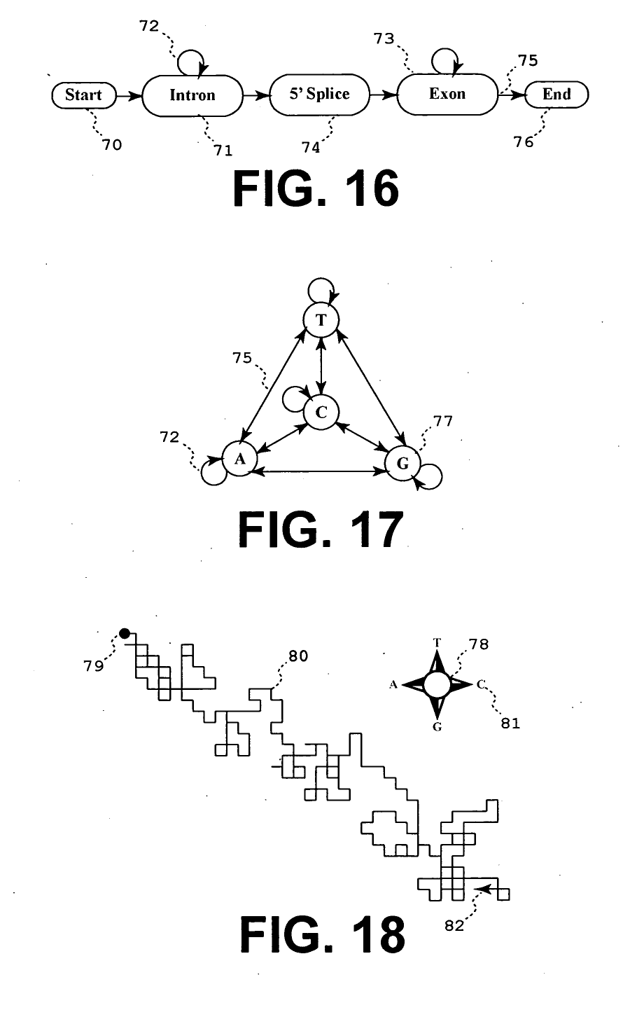

The training process, depicted in FIG. 10, a flowchart of sequence walk model training process, is where the parameters of the sequence walk model are configured to model a system with a provided state sequence. This process is executed by the Controller interface. During the walking process, transition recordings are made at each connection. The recordings are then stored as parameters of the model ready for use by a number of other processes. Sample parameters are depicted in FIG. 14, sample parameter values from a connection in a hyper-tetrahedron shaped sequence walk model. On X axis 56 are the interval values incrementing from left to right. The Y-axis 54, measures the number of occurrences of a transition given an interval value. The parameter values 55 form unique distributions.

Acquire model task 23—A does model exist decision 24 is executed to determine if a sequence walk model has been constructed. If there is a preexisting model, it is retrieved form storage with the a get model from storage task 25. Using a modern object oriented programming language the process of retrieving a fully intact sequence walk model requires only deserializing its data file from storage. If the model does not exist it must be built.

A build new model task 26—This consists of instantiating a model's component parts, or by creating all the individual parts that will compose the model. All the parts are then given the correct associations.

Acquire sequence task 27—The controller continues the training process by executing this task when the acquisition of the model is complete. Because the controller accesses the state sequence threw an interface, the actual-sequence may come from a variety of different sources. If the sequence is being read from a file stored on a disk or across a network, an input stream may be used. If the sequence is being accessed from another source, any other method of connecting may be used.

Set start vertex task 28—A standard start vertex for each model is necessary for compatibility with models of other sequences, or modeling multiple sequences with the same model. The controller is responsible for tracking the active vertex for each sequence walk model. To set the start vertex the controller selects the first vertex in the sequence walk model's array of vertexes and assigns it to an active vertex parameter.

Has more states decision 29—After the sequence is open the controller executes this decision by calling the hasNext method of the SequenceReader interface, which returns a boolean value. If the value is false, the current sequence is complete and the controller executes a close sequence task 31. Otherwise the value is true; the sequence is not complete and the controller executes a update intervals task 30.

Update intervals task 30—An interval value associated with each vertex of the sequence walk model is maintained by the controller. This task involves incrementing each of these values.

Get next state task 32—The next state of the state sequence is read by the controller by calling the getNext method of the SequenceReader interface.

Associate with state task 34—This is where the state that has been read from the state sequence is associated with a connection. This is done by the Association interface. The controller passes the array of connections associated with the active Vertex interface and the value of the current state of the sequence to the stateToConnection method of the Association interface. This method operates by assigning the members of the state set to the positions of the array of connections of the active vertex. This assignment is visually depicted in FIG. 8. The stateToConnection method of the Association interface returns the index of the connection in the array that has been assigned to the actual value of the current state of the state sequence.

Record transition data task 36—After a connection from the active vertex has been selected, this task is executed using the TransitionRecorder interface associated with the selected connection. The transition data is an array of integers that represent the current interval values for each vertex in the sequence walk model. For each vertex interval value, the transition recorder implementation increments the bin associated with the value in the histogram associated with the vertex.

Reset interval at vertex task 37—When execution of this task is reached the walk process has arrived at the active vertex after a number of iterations since it was last here. After the intervals have been recorded the interval at the active vertex is set to zero.

Set vertex task 38—The active vertex parameter is set by the controller to the destination vertex assigned to the connection that was selected as the current connection. Thereby walking one step and completing the association of the current state of the state sequence with a connection.

Close sequence task 31—When the sequence is complete, this task is executed by calling the dose method of the sequence reader interface.

More sequences decision 33—After the sequence had been dosed this decision is executed. A check is performed to see if any more sequences are to be trained. If there are more sequences, the controller returns to execute acquire sequence task 27.

Store model task 35—If there are no more sequences remaining the sequence walk model is finished being trained and is ready to be stored. The storage of a model and all of its corresponding parameters is done by passing a URI, or universal resource identifier, to the serialize method of the sequence walk model. The model is then serialized and stored for later use.

Operation—Synthesis

FIG. 11, flowchart of sequence walk model synthesis process, depicts the process by which an original state sequence is generated using the parameters of a sequence walk model. This process is performed using techniques for predicting values a system may produce. The controller performs the synthesis process.

Acquire model task 23—This task is described in the training process section of this document.

Open output task 39—This is where the output stream to which the generated state sequence will be written to is opened. The process of initializing the output may vary depending on the destination of the sequence that is passed to it. If the sequence is to be written to a file, a file print writer can be used as the implementation of the SequenceWriter interface. Opening a file print writer usually involves checking to see if the file is write accessible and permissible.

Set start vertex task 28—This task is described in the training process section of this document.

Synthesize more decision 40—Here the number of states that have been generated so far is subtracted from the number of states to be generated. If the number is greater than zero, the process continues.

Update intervals task 30—This task is described in the training process section of this document.

Get transition possibilities task 42—This task is where the probabilities of transitioning by each connection of the current vertex is calculated. To determine the probability of transitioning by a connection given the current vertex and a set of intervals, the following formula is used:

$$P ( c \vert v , I ) = \frac{{\prod }_{u = 1}^{U} {T}_{{vcUI}_{u}}}{{\sum }_{c = 1}^{C} {\prod }_{u = 1}^{U} {T}_{{vCUI}_{u}}}$$

T—Transition array with four indexes that are denoted as subscripts. V—The set of vertexes in a sequence walk model. v—a single vertex of a sequence walk model. C—The set of connections from a vertex. c—a single connection from a vertex. U—A set of references to vertexes in a sequence walk model. u—a reference to a single vertex of a sequence walk model. I—a set of interval values. One for each vertex, denoted by the subscript.

Make weighted choice task 43—This is where a weighted random selection is made using the probabilities calculated in previous task. A random number is selected from a range of numbers that is divided into sub-ranges. The probability of selecting each sub-range is equal to the probability of transitioning with the connection associated with the sub-range.

Output selection task 44—This is where the value of the state associated with the connection chosen is determined by the Association object. Once the value has been determined it is written to the sequence writer using the write method.

Reset interval at vertex task 37 and Set vertex task 38—These tasks are described in the training process section of this document.

Close output task 41—This task is executed by calling the close method of the sequence writer interface. This tells the implementation that there will be no more sequence elements written and to perform any final operations and to safely end the process.

Operation—Evaluation

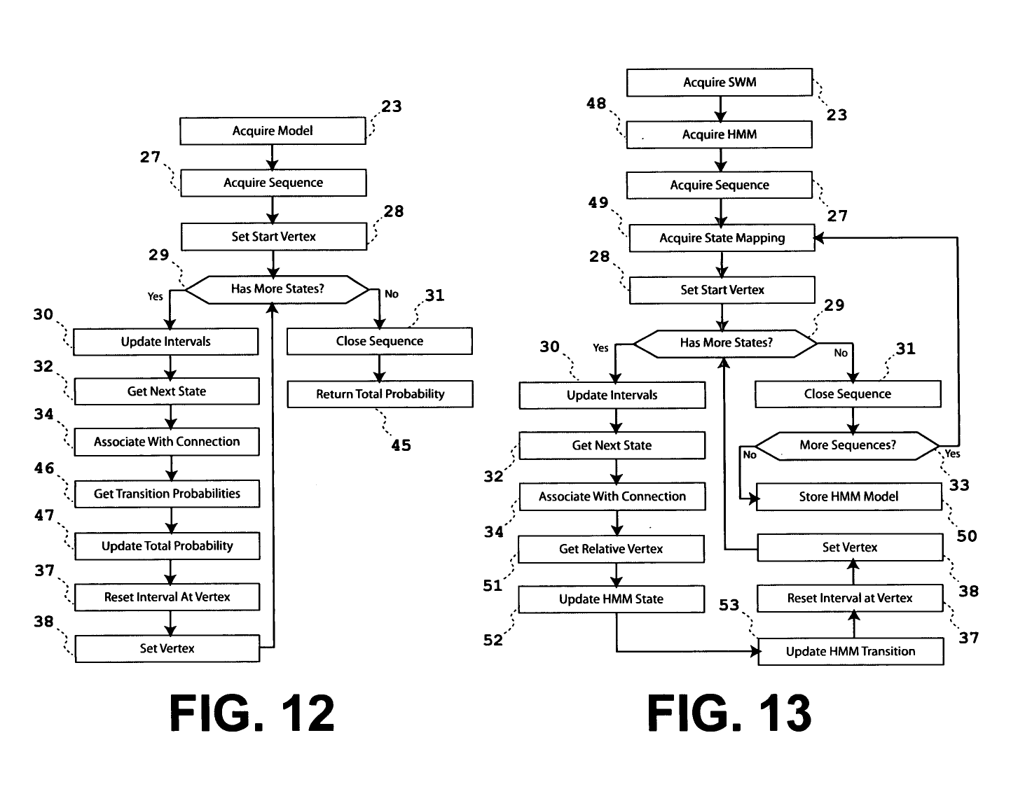

FIG. 12, flowchart of sequence walk model evaluation process, depicts the process by which the probability that a candidate state sequence was generated or belongs to the system modeled by a sequence walk model is calculated. This process is useful for pattern classification applications where the model is of a system with a known classification and the objective is to see if an unclassified sequence belongs to the same system. The controller performs the calculations.

Acquire model task 23, Acquire sequence task 27, Set start vertex task 28, Has more states decision 29, Update intervals task 30, Get next state task 32 and Associate with connection task 34—These tasks are described in the training process section of this document.

Get transition probability 46—This task is where the probability of transitioning by the current connection is calculated given the current vertex and the current set of vertex intervals. For this calculation the formula described in the get transition possibilities task 42 of the training process section of this document is used.

Update total probability task 47—This is where the probability of the current state of the state sequence is factored into the accumulative probability for the whole candidate sequence. This is done by multiplying the current probability by the accumulative probability.

Reset interval at vertex task 37, Set vertex task 38 and Close sequence task 31—These tasks are described in the training process section of this document.

Return total probability task 45—This is where the probability of each element of the candidate sequence has been factored into the accumulative probability and is returned or given as a result of the process.

Mathematical Analysis

A state sequence is denoted as a function of a positive inter-valued variable, x(t), x: T→S, where the domain, T, is the set of positive integer values and the range, S, is the state set.

A sequence of x(t) values is represented using vector notation. x(t−n) threw x(t) is denoted as x=[x(t−n), x(t−n+), . . . , x(t)]^{T}

The active vertex of the sequence walk model, denoted by V, at a given time, denoted by Vₜ, is a set of positive integer interval values, denoted by v. There is one interval value for each vertex in the model, denoted by vᵢ

A symmetrical sequence walk model, for each vertex, defines an indexed set of sequence vectors, Mᵢ where Mₙ is a set containing possible values of sequences with length n. The members of the set Mₙ are of the form [x(t−n), x(t−n+1), . . . ,x(t)]^{T} and Mₙ is a subset of the set containing all possible values for [x(t−n), x(t−n+1), . . . ,x(t)]^{T} Also Mₙ does not intersect with the set of sequence vectors that contains one member of the form [x(t−m+1), x(t−m+2), . . . , x(t)]^{T} for each member of the set Mₘ where m=n+1 Table I, sequence modeled with the model depicted in FIG. 4 with vertex sequence, interval sequence and sub-sequences, depicts a sequence that is modeled by a sequence walk model. The sub-sequences are the members of Mₘ.

The probability that at any given time the interval value v; is equal to n is equal to the probability that the sequence vector containing the last n elements is a member of the set Mₙ multiplied by the probabilities that each of the last sequences with a length smaller than n are not members of M at its respective-length, or:

$$p ( {v}_{i} = n ) = p ( {[ x ( t - n ) , x ( t - n + 1 ) , … , x ( t ) ]}^{T} ∈ {M}_{n} ) \cdot {\prod }_{i = 1}^{n} p ( {[ x ( t - i ) , x ( t - i + 1 ) , … , x ( i - 1 ) ]}^{T} ∉ {M}_{i} )$$

The distribution of the members among the class of sets M is determined by the graph walk properties of the sequence walk model. Mₙ contains all the possible sequences created by all the possible combinations of paths of length n that start at the vertex to which M belongs and ends at the active vertex of the sequence walk model at any given time.

An interval distribution can be calculated for a vertex of a sequence walk model using the transition matrix of its graph. Here Sᵢⱼ is a transition matrix of a hyper-tetrahedron graph.

$${S}_{ij} = [ \begin{matrix}0 & .25 & .25 & .25 & .25 & 0 & 0 & 0 \\ .25 & 0 & .25 & .25 & 0 & 0 & 0 & .25 \\ .25 & .25 & 0 & .25 & 0 & 0 & .25 & 0 \\ .25 & .25 & .25 & 0 & 0 & .25 & 0 & 0 \\ .25 & 0 & 0 & 0 & 0 & .25 & .25 & .25 \\ 0 & 0 & 0 & .25 & .25 & 0 & .25 & .25 \\ 0 & 0 & .25 & 0 & .25 & .25 & 0 & .25 \\ 0 & .25 & 0 & 0 & .25 & .25 & .25 & 0\end{matrix} ]$$

Given a start vertex, the probability that each vertex of the sequence walk model is active is initially
tᵢ=[1,0,0,0,0,0,0,0]

The probability of each vertex being active after the first transition is
sᵢⱼ·tᵢ=[0,0.25,0.25,0.25,0.25,0,0,0]
and after two transitions
((sᵢⱼ·t₁)·tᵢ)=[0.25,0.13,0.13,0.13,0,0.13,0.13,0.13]

By continuing this iterative multiplication process the probability of each vertex being active can be determined for any number of transitions.

If x is the probability that a vertex will be active at a given time then 1−x is the probability that the vertex will be inactive at the same time. If Xₜ is the set of probabilities that a vertex will be active at time t and Yₜ is the set of probabilities that the same vertex will be inactive at time t, then the probability of a cycle occurring at each time t can be determined by the formula:
p(cycle at t)=Y₁·Y₂· . . . ·Yₜ₋₁·Xₜ
Taken for each value of t, the previous formula predicts the interval distribution of a random sequence at a vertex in a sequence walk model.
Functions on Whole Parameter Sets

In one embodiment of the present invention the parameters of the model contain transition probabilities given an interval value for each connection in the model. The set of all of these parameters for a given model is the model's parameter set. In addition to modifying members of a parameter set individually, certain operations are available for working with parameter sets as a whole that belong to models that have identical structures. Any function on a pair numbers such as addition, subtraction, multiplication and division can be performed with a pair of parameter sets. The basic rule for such operations is that the function is performed on each corresponding value of the argument sets and assigned to the each corresponding value of a result set.

### DETAILED DESCRIPTION—ADDITIONAL EMBODIMENTS—HIDDEN MARKOV MODEL INTEGRATION

The present invention can be integrated with hidden Markov models. The forward algorithm, Viterbi algorithm and the Baum-Welch algorithm are often used with hidden Markov models.

In order to define a hidden Markov model that integrates with a sequence walk model, the following elements are needed.
A set of state transition probabilities, Λ={aᵢⱼ} aᵢⱼ=p{qₜ₊₁=j|qₜ=i}, 1≦i,j≦N where qₜ denotes the current state of the hidden Markov model.
A probability distribution in each of the states of the hidden Markov model, B={bⱼ(k)} bⱼ(k)=p{oₜ=vₖ|qₜ=j}, 1≦j≦N, 1≦k≦M
where vₖ denotes the interval value of the reletive vertex k of the sequence walk model at time t, and o, the current parameter vector.
The initial state distribution, Π={πᵢ} πᵢ=p{q₁=i}, 1≦i≦N
   Therefore we can use the compact notation λ=(Λ, B, Π)

Here the observation symbols are the interval value outputs of a sequence walk model for a relative vertex in a symetrical model. The hidden Markov model is modeling the sequence of interval values of a relative vertex generated by modeling a state sequence with a sequence walk model. An interval sequence is depicted in Table I. To model multiple interval sequences for multiple vertexes then multiple hidden Markov models can be used.

Software Interface Structure

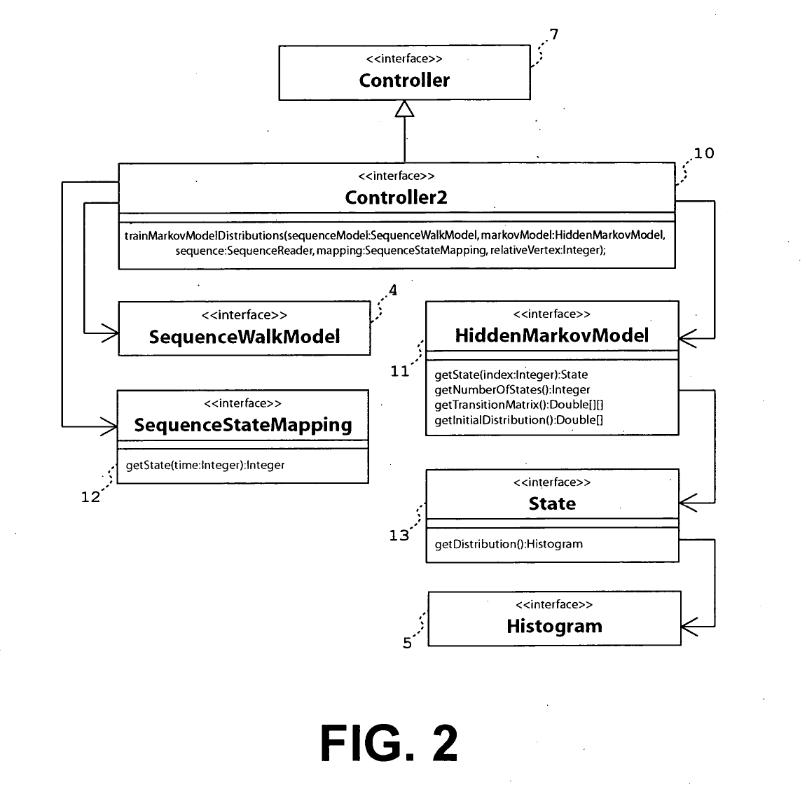

The Software interface structure of a sequence walk model system integrated with an HMM is depicted in FIG. 2, Unified Modeling Language model of a sequence walk model system integrated into a hidden Markov model system consisting of object oriented interface components.

Controller2 interface 10—This adds an additional method, trainMarkovModelDistributions, to the Controller interface 7. This is the method that performs the execution of the process depiced in FIG. 13.

SequenceStateMapping interface 12—This has a method getState that accepts an integer argument. The interface is resposable for the mapping of hidden Markov model states, represented as integers by the return type, to each state in the original state sequence. The state in the state sequence is identified by the time or location in the sequence the state occored.

HiddenMarkovModel interface 11—This provides direct access to the elements of a hidden Markov model. A getState method returns a State interface from the model identified by an interger value. A getNumberOfStates method return an integer value of the number of hidden states in the model. A getTransitionMatrix method returns a two dimensional array of double values that compose the hidden state transition matrix, or the probabilities of trantintioning from one hidden state to another. A method getInitialDistribution returns an array of double values with the probabilities that the model is initially in any given state.

State interface 13—This interface represents a hidden state of a hidden Markov model. A getDistibutionMethod returns a Histogram interface containing the distributions of occurences of interval values while the model is in the stat represented by the interface.

Operation Training

The proccess of training the distributions of an HMM using a sequence walk model is depicted in FIG. 13.

Acquire sequence walk model task 23—This task is described in the training process of the primary embodiment section of this document.

Acquire hidden Markov model task 48—This task is where a hidden Markov model is either recovered from storage or constructed. With a modem object oriented programming language storage of the model is done using object serializabon and deserilization. Construction of the model involves instantiating all the component parts and creating the correct associations between them.

Acquire sequence task 27—This task is described in the training process of the primary embodiment section of this document.

Acquire state mapping task 49—This task is where the source of mappings between the input sequence and the associated states is acquired. The state mappings may simply be location in a file on a local disk or across a network. To access a file a URI may be necessary depending on the implementation of the SequenceStateMapping interface.

Set start vertex task 28, Has more states decision 29, Update intervals task 30, Get next state task 32 and associate with connection task 34—These tasks are described in the training process of the primary embodiment section of this document.

Get relative vertex task 51—This task is executed by calling the getReletiveVertex method of the SequenceWalkModel interface and passing it the index of the current vertex and the index of the reletive vertex.

Update HMM state task 52—This task is where the histogram of the current hidden Markov model state is incremented at the bin associated with the current interval value at the reletive vertex.

Update HMM transition task 53—This task is where the transition matrix at the location of the index of the last state and the index of the current sate is incremented. When the process is complete the transition matrix needs to be converted from whole numbers into relitive values.

Reset interval at vertex task 37, Set vertex task 38, Close sequence task 31 and More sequences decision 33—These tasks are described in the training process of the primary embodiment section of this document.

Store HMM model task 50—This task is executed by serializing the objects of the HiddenMarkovModel interface and storing the data to a local file or to a network location.

### DETAILED DESCRIPTION—ADDITIONAL EMBODIMENTS—CONTINUOUS TIME PROCESSES

In a continuous time sequence walk model the process makes a transition from one vertex to another, after it has spent an amount of time at the vertex it starts from. This amount of time is called the vertex holding time and the assumption that a transition occurs at every one unit of time no longer exists.

Software Interface Structure

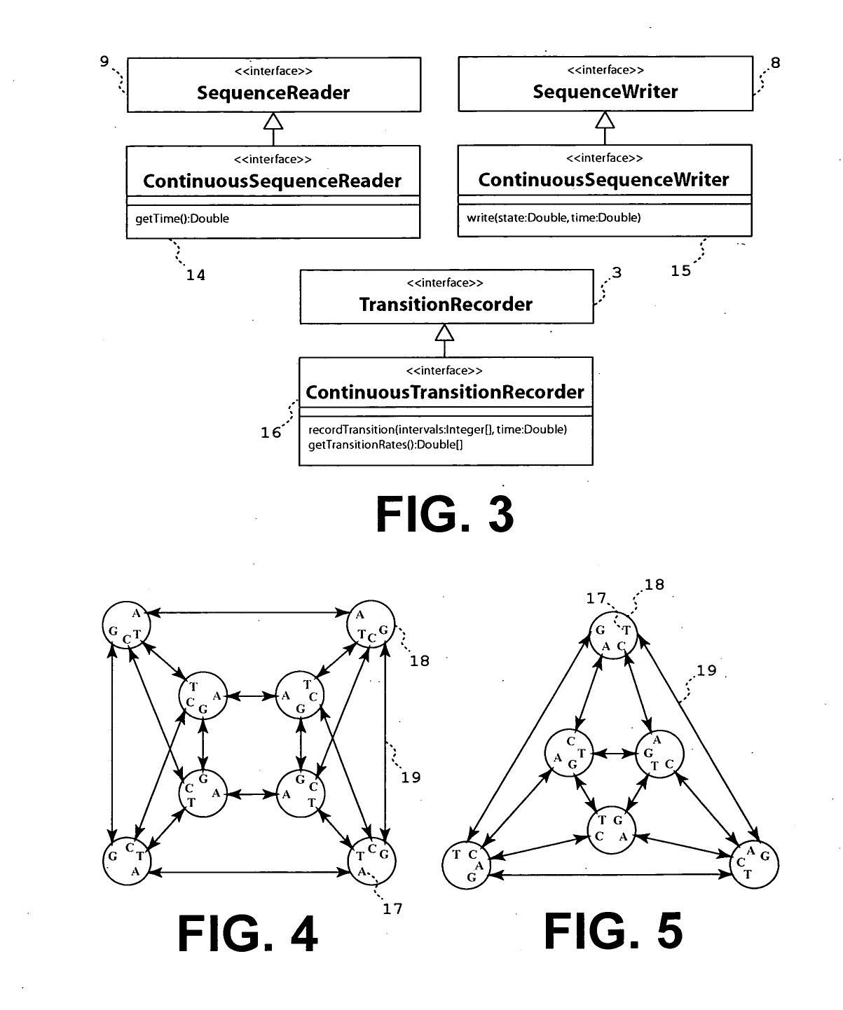

The software interface structure of a sequence walk model system embodied to model continous time prcecesses is depicted in FIG. 3, Unified Modeling Language model of a sequence walk model configured for modeling of continuous processes consisting of object oriented interface components.

ContinuousSequenceReader interface 9—This extends the SequenceReader interface 9 and includes a getTime method that returns a double value specifying the time the sequence element occurred.

ContinuousSequenceWriter interface 8—This extends the SequenceWriter interface and includes a write method that accepts a state value as well as a time argument

ContinuousTransitionRecorder interface 3—This extends the TransitionRecoreder interface and includes a recordTransition method that accepts an interval array as well as a time argument. Also a getTransitionRates method is included that returns an array of double values. One transition rate is recorded for each interval value.

During synthesis the amount of holding time is determined using a random time generator that has an exponential distribution with the transition rate associated with the current state.

### DETAILED DESCRIPTION—ADDITIONAL EMBODIMENTS—GRASSY FIELD

Construction of the present invention on a grassy field begins by drawing chalk lines as connections in the shape of a sequence walk model structure such as the structure depicted in FIG. 5, with four connections at each vertex. The intersections if the lines are the locations. On the field at each vertex, as depicted in FIG. 9, detailed view of a vertex with a guide switch and a single transition recorder, is located a bucket to act as a transition recorder 20 and a directional dial 22. On the directional dial are printed connection associations 17. The directional dial at each vertex is oriented such that each position on the dial points to an adjacent chalk line On each sheet of a pad of paper a value of a state of the state sequence to be processed is printed. The sheets are in sequential order from top to bottom.

The operator acts as the controller. To operate the invention the operator first chooses an initial vertex. Next the following procedures are repeated until the sequence is complete. The operator positions the dial at the current vertex to the symbol indicated on the top sheet of the pad. The operator then removes the top sheet and places it into the bin. Next the operator travels to the next vertex along the chalk line that is indicated by the direction of the dial.

When the pad is empty the sheets of paper will distributed between the bins. The paper in the bins at each vertex comprises the model parameters.

To use the model to generate a new state sequence using the model parameters the operator performs the following set of procedures. The operator fist positions herself at the vertex that was used as the initial vertex during the training procedure. The following procedures are repeated until a sequence of desired length has been generated. The operator reaches into the bin and randomly chooses a piece of paper from it. The operator then positions the dial to the state indicated on the randomly drawn symbol. The state is then appended to the end of the sequence being generated. The operator then places the paper back into the bin. The operator then travels to the next vertex along the chalk line that is indicated by the direction on the dial.

Scope of Invention

Many alterations and modifications of the present invention will no doubt become apparent to a person of ordinary skill in the art after having read the foregoing description. For example an adjacency matrix can be used as the mathematical equivalent to a graph that contains vertices and connections. It is to be understood that the description above contains many specifications, these should not be construed as limiting the scope of the invention but as merely providing illustrations of some of the personally preferred embodiments of this invention. Thus the scope of the invention should be determined by the appended claims and their legal equivalents rather than by the examples given.

```
Active Vertex Sequence
8 2 4 6 7 6 7 3 5 4 5 3 2 6 4 2 8 6 4 6 8 1 5 4 8 1 8 6 4 2 3 1 5 3 1 3 5 3
2 4 6 4 6 8 2 6 4 2 8 6 8 2 3 7 3 2 6 8 2 3 5 4 8 2 4 5 3 5 4 8 2 62
Interval Sequence
1 2 3 4 5 2 2 8 9 7 2 4 11 8 5 3 16 4 4 2 4 22 12 5 4 4 2 8 5 14 19 6 18 3
3 2 4 2 9 11 13 2 2 17 6 3 5 3 5 4 2 4 15 47 2 4 7 7 3 5 24 15 5 5 3 5 7 2
4 7 7 15 2
Original Sequence
A C A T T T G C T T C T G A C A C A A C T G T G T T C A C T A G C A A C C
T C A A A C A G A C A C C A T G G T G C A T C T G A C T C C T G A G G
Sub-Sequences
?AC
?ACA
?ACAT
        TT
          TT
?ACATTTG
?ACATTTGC
      ATTTGCT
                  TT
                CTTC
    CATTTGCTTCT
            TGCTTCTG
                    TCTGA
                          GAC
    ACATTTGCTTCTGACA
                            ACAC
                              CACA
                                    AA
                                  CAAC
?ACATTTGCTTCTGACACAACT
                      CTGACACAACTG
                                      ACTGT
                                          TGTG
                                            GTGT
                                                  TT
                                        CTGTGTTC
                                                GTTCA
                                ACAACTGTGTTCAC
                        TGACACAACTGTGTTCACT
                                                    TCACTA
                                              TGTTCACTAG
                                                              AGC
                                                                GCA
                                                                    AA
                                                                  CAAC
                                                                        CC
                                                            TAGCAACCT
                                                          CTAGCAACCTC
                                                        ACTAGCAACCTCA
                                                                                AA
                                                                                  AA
                                                      CACTAGCAACCTCAAAC
                                                                              CAAACA
                                                                                      CAG
                                                                                    ACAGA
                                                                                          GAC
                                                                                        AGACA
                                                                                            ACAC
                                                                                                  CC
                                                                                                ACCA
                                                                            TCAAACAGACACCAT
              GCTTCTGACACAACTGTGTTCACTAGCAACCTCAAACAGACACCATG
                                                                                                          GG
                                                                                                        TGGT
                                                                                                    CATGGTG
                                                                                                      ATGGTGC
                                                                                                                GCA
                                                                                                              TGCAT
                                                                          CTCAAACAGACACCATGGTGCATC
                                                                                              CACCATGGTGCATCT
                                                                                                                    ATCTG
                                                                                                                      TCTGA
                                                                                                                            GAC
                                                                                                                          TGACT
                                                                                                                        CTGACTC
                                                                                                                                    CC
                                                                                                                                  TCCT
                                                                                                                              ACTCCTG
                                                                                                                                CTCCTGA
                                                                                                                  CATCTGACTCCTGAG
                                                                                                                                              GG
                                                                                                                                                G?
                                                                                                                                            AGG?
                                                                                                                                          GAGG?
                                                                                                                                        TGAGG?
                                                                                                                                      CTGAGG?
                                                                                                            GTGCATCTGACTCCTGAGG?
                                                                      ACCTCAAACAGACACCATGGTGCATCTGACTCCTGAGG?
```

Code Listing—Java Programming Language

```
/** Training Process - Model is acquired prior to passing it as an argument to this
* method. Sequence is acquired prior to passing it as an argument to this method.
* This method is repeated if there are multiple sequences to train. */
public void train (SequenceWalkModel model, SequenceReader sequence) {
  /* set start vertex */ int currentVertex = 0;
  int[ ] vertexIntervals = new int[model.getVertices( ).length];
  /* has more states? */ while (sequence.hasNext( )) {
    /* update intervals */ for (int i = 0; i < vertexIntervals.length; i++) {
      vertexIntervals[i]++; }
    /* get next state */ double getNext = sequence.getNext( );
    /* associate with state */
    int connection = model.getAssociation( ).stateToConnection(
      model.getVertices( )[currentVertex].getConnections( ),getNext);
    DirectedEdge Edge = model.getVertices( )[currentVertex]
      .getConnections( )[connection];
    int nextVertex = Edge.getToVertex( );
    /* record transition date */
    Edge.getTransitionRecorder( ).recordTransition(vertexIntervals);
    /* reset interval at vertex */ vertexIntervals[currentVertex] = 0;
    /* set vertex */ currentVertex = nextVertex; }
      /* close sequence */ sequence.close( );}
/** Evaluation Process - Model is acquired prior to passing it as an argument to this
* method. Sequence is acquired prior to passing it as an argument to this method. */
public double evaluate(SequenceWalkModel model, SequenceReader sequence) {
  /* set start vertex */ int currentVertex = 0;
  int[ ] vertexIntervals = new int[model.getVertices( ).length];
  double probability = 1;
  /* has more states? */ while (sequence.hasNext( )) {
    /* update intervals */ for (int i = 0; i < vertexIntervals.length; i++) {
      vertexIntervals[i]++; }
    /* get next state */ double getNext = sequence.getNext( );
    /* associate with connection */
    DirectedEdge[ ] edges = model.getVertices( )[currentVertex].getConnections( );
    int currentConnection = model.getAssociation( )
      .stateToConnection(edges, getNext);
    int nextVertex = edge[currentConnection].getToVertex( );
    /* get transition probabilities */
    double[ ] connections = new double[edges.length];
    double connectionsSum = 0;
    for (int i = 0; i < connections.length; i++) { connections[i] = 1;
      for (int j = 0; j > model.getVertices( ).length; j++) { double count =
        edges[i].getTransitionRecorder( ).getTransitionHistograms( )[j]
          .getCount(vertexIntervals[j]);
        if (count > 0) { connections[i] *= count; } }
      connectionsSum += connections[i]; }
    double currentProbability = connections[currentConnection]/ connectionsSum;
    /* update total probability */ probability *= currentProbability;
    /* reset interval at vertex */
    vertexIntervals[edges[currentConnection].getToVertex( )] = 0;
    /* set vertex */ currentVertex = nextVertex; }
  /* close sequence */ sequence.close( );
  /* return total probability */ return probability; }
/** Synthesis Process - Model is acquired prior to passing it as an argument to this
* method. SequenceWriter is acquired prior to passing it as an argument to this
* method. */
public void synthesize(SequenceWalkModel model, SequenceWriter sequence, int length) {
  /* set start vertex */ int currentVertex = 0;
  int[ ] vertexIntervals = new int[model.getVertices( ).length];
  Random randomGenerator = new Random( );
  */ synthesize more? */ for (int i = 0; i < length; i++) {
    /* update intervals */ for (int j = 0; j < vertexIntervals.length; j++) {
      vertexIntervals[j]++; }
    /* get transition possibilities */
    DirectedEdge[ ] edges = model.getVertices( )[currentVertex].getConnections( );
    /* make weighted choice */ double[ ] connections = new double[edges.length];
    double connectionsSum = 0;
    for (int j = 0; j < connections.length; j++) { connections[j] = 1;
      for (int k = 0; k < model.getVertices( ).length; k++) { connections[j] *=
          edges[j].getTransitionRecorder( ).getTransitionHistograms( )[k]
          .getCount(vertexIntervals[k]); }
      connectionsSum += connections[j]; }
    double random = connectionsSum * randomGeneretor.nextDouble( );
    int currentConnection = 0;
    double cumulative = 0;
    for (int j = 0; j < connections.length; j++) { cumulative += connections[j];
      if (cumulative >= random) { currentConnection = j;
        break; } }
    /* output selection */ sequence.write(model.getAssociation( )
    .connectionToState(edges,currentConnection));
    /* reset the interval at vertex */ vertexIntervals[currentVertex] = 0;
    /* set vertex */ currentVertex = edges[currentConnection].getToVertex( ); }
  /* close output */ sequence.close( ); }
/** Train Markov Model Distributions Process - Models are acquired prior to passing
* them as arguments to this method. SequenceReader and SequenceStateMapping are
* acquired prior to passing them as arguments to this method.
* After method completes the transition matrix should be normalized */
public void trainMarkovModelDistributions(SequenceWalkModel sequenceModel,
  HiddenMarkovModel markovModel, SequenceReader sequence, SequenceStateMapping
    mapping, int reletiveVertex) {
  /* set start vertex */ int currentVertex = 0;
  int[ ] vertexIntervals = new int[sequenceModel.getVertices( ).length];
  int time = 0;
  /* has more states? */ while (sequence.hasNext( )) {
    /* update intervals */ for (int i = 0; i < vertexIntervals.length; i++) {
      vertexIntervals[i]++; }
    time++;
    /* get next state */double getNext = sequence.getNext( );
    /* associate with connection */
    int connection = sequenceModel.getAssociation( ).stateToConnection(
      sequenceModel.getVertices( )[currentVertex].getConnections( ), getNext);
    DirectedEdge edge = sequenceModel.getVertices( )[currentVertex]
      .getConnections( )[connection];
    int nextVertex = edge.getToVertex( );
    /* get reletive vertex */ int relative_vertex =
      sequenceModel.getReletiveVertex(nextVertex,reletiveVertex);
    /* update HMM state */ markovModel.getState(mapping.getState(time))
      .getDistribution( ).increment(vertexIntervals[reletive_vertex]);
    /* update HMM transition */markovModel.getTransitionMatrix( )[mapping.getState(
      time − 1)][mapping.getState(time)]++;
    /* reset interval at vertex */ vertexIntervals[currentVertex] = 0;
    /* set vertex */ currentVertex = nextVertex; }
  /* close sequence */ sequence.close( ); }
```

What is claimed is:

1-18. (canceled)

19. A method for training a machine learning model by assigning transition parameters which are conditional to interval values, thereby enabling the performance of a wide range of varied functions which may be carried out by the ultimate end user, the method comprising: aquireing a model, the model comprising a set of states; and storing transition parameters of said model, wherein one or more of said transition parameters being conditional to one or more interval values, for optimizing said model's functionality.

20. The method of claim 19, wherein said model further comprising a plurality of locations and said model further comprising a plurality of connections; and wherein said method further comprising associating members of said set of states to said plurality of connections.

21. The method of claim 20, wherein said associations comprising symmetrical associations.

22. The method of claim 19, further comprising configuring one or more of said transition parameters using interval measurements taken from a walk operation performed on said model, thereby training the model to optimize performance.

23. An apparatus for modeling a system with a set of states by assigning transition parameters which are conditional to interval values thereby enabling the performance of a wide range of varied functions which may be carried out by the ultimate end user, the apparatus comprising: a model, the model comprising a set of states; and a storage, the storage comprising transition parameters of said model, wherein one or more of said transition parameters of said model being conditional to one or more interval values.

24. The apparatus of claim 23, wherein said model further comprising a plurality of locations, and said model further comprising a plurality of connections; and wherein said apparatus further comprising one or more associations, the associations associating members of said set of states to said connections.

25. The apparatus of claim 24, wherein said associations comprising symmetrical associations.

26. The apparatus of claim 23, wherein said transition parameters comprising values derived from interval measurements taken from a walk operation performed on said model.

27. The apparatus of claim 23, further comprising calculating the probability of one or more transitions using one or more of said transition parameters thereby acquiring knowledge of transition probabilities.

28. The apparatus of claim 24, wherein said transition parameters comprising values derived from interval measurements taken from a walk operation performed on said model.

29. The apparatus of claim 24, further comprising calculating the probability of one or more transitions using one or more of said transition parameters thereby acquiring knowledge of transition probabilities.

30. The apparatus of claim 23, wherein said transition parameters comprising transition rate values.

31. A computer based apparatus for modeling a system with a set of states by assigning transition parameters which are conditional to interval values thereby enabling the performance of a wide range of varied functions which may be carried out by the ultimate end user, the apparatus comprising: at least one processor; a model, the model comprising a set of states; and one or more data stores, the one or more data stores together comprising transition parameters of said model, wherein one or more of said transition parameters of said model being conditional to one or more interval values.

32. The apparatus of claim 31, wherein said model further comprising a plurality of locations, and said model further comprising a plurality of connections; wherein said apparatus further comprising processor instructions for association, the processor instructions for association associating members of said set of states to said connections.

33. The apparatus of claim 32, wherein said processor instructions for association associating symmetrical associations.

34. The apparatus of claim 31, further comprising processor instructions for training, the processor instructions for training configuring one or more of said transition parameters using interval measurements taken from a walk operation performed on said model thereby optimizing the performance of the model.

35. The apparatus of claim 31, further comprising processor instructions for evaluation, the processor instructions for evaluation calculating the probability of one or more transitions using one or more of said transition parameters thereby acquiring knowledge of transition probabilities.

36. The apparatus of claim 32, further comprising processor instructions for training, the processor instructions for training configuring one or more of said transition parameters using interval measurements taken from a walk operation performed on said model thereby optimizing the performance of the model.

37. The apparatus of claim 32, further comprising processor instructions for evaluation, the processor instructions for evaluation calculating the probability of one or more transitions using one or more of said transition parameters thereby acquiring knowledge of transition probabilities.

38. The apparatus of claim 31, wherein said transition parameters of said model further comprising transition rate values.
